(19) United States
(12) Patent Application Publication
(10) Pub. No.: US 2024/0054590 A1
(43) Pub. Date: Feb. 15, 2024

(54) INFORMATION PROCESSING DEVICE, METHOD, AND PROGRAM

(71) Applicant: SONY GROUP CORPORATION, TOKYO (JP)

(72) Inventors: KOKI TAKAHASHI, TOKYO (US); YOSHIHIKO IKENAGA, (US); KAZUHIRO WATANABE, (US)

(21) Appl. No.: 17/754,487

(22) PCT Filed: Oct. 2, 2020
(86) PCT No.: PCT/JP2020/037599

§ 371 Date: Apr. 4, 2022

(30) Foreign Application Priority Data
Oct. 11, 2019 (JP) 2019-187423

(51) Int. Cl. G06Q 50/20

(52) U.S. Cl. CPC G06Q 50/205; G06Q 2220/00

(57) ABSTRACT

The present technology relates to an information processing device, a method, and a program that enable more reliable evaluation. An information processing device includes: an acquisition unit that acquires, for a plurality of evaluators, evaluation data indicating evaluation of an evaluation target generated by the evaluator and a value indicating worth of the evaluator; a conversion unit that converts the evaluation data into absolute evaluation data on the basis of the evaluation data and the value indicating the worth of the plurality of evaluators; and a controller that performs control to record the absolute evaluation data in a distributed ledger. The present technology can be applied to a blockchain network.

### TECHNICAL FIELD

The present technology relates to an information processing device, a method, and a program, and more particularly to an information processing device, a method, and a program that enable more reliable evaluation.

### BACKGROUND ART

Conventionally, there have been proposed services and technologies in which data regarding learning and education is recorded in a blockchain and the data is shared by learners, educators, and the like (see Patent Document 1, for example).

For example, if a score of a test taken by a learner is recorded in the blockchain as learning data, various users such as schools, cram schools, and persons related to placement services can browse the learning data of the learner and use the learning data for providing services and the like.

In this example, the learning data written to the blockchain is evaluation data indicating an evaluation result when a test provider such as a cram school serves as an evaluator and the evaluator evaluates the learner by the service that is the test.

By browsing such learning data, the user such as a school, a cram school, and a person related to a placement service can comprehensively evaluate the learner on the basis of the learning data, and perform learning guidance or placement.

### CITATION LIST

### Patent Document

Patent Document 1: Japanese Patent Application Laid-Open No. 2018-169856

### SUMMARY OF THE INVENTION

### Problem to be Solved by the Invention

Incidentally, when a blockchain platform spreads and develops, the learner is evaluated by various people and organizations, and learning data that is the evaluation result is written in the blockchain.

In such a case, it may be difficult for the viewer of the learning data to appropriately evaluate the ability or the like of the learner from the content of the browsed learning data, that is, the evaluation result of evaluating the learner. In other words, there may be cases where the viewer cannot evaluate the degree of performance of the score indicated by the learning data appropriately.

Specifically, for example, if the score indicated by the learning data is a score of a test that is widely and generally known, the viewer can evaluate the ability or the like of the learner appropriately by viewing the score.

However, in a case where the score indicated by the learning data is a score of a test that is not generally known, there may be a case where the viewer cannot evaluate the ability or the like of the learner appropriately.

The present technology has been made in view of the foregoing, and aims to achieve more reliable evaluation.

### Solutions to Problem

An information processing method or a program according to a first aspect of the present technology includes: an acquisition step of acquiring, for a plurality of evaluators, evaluation data indicating evaluation of an evaluation target generated by the evaluator and a value indicating worth of the evaluator; a conversion step of converting the evaluation data into absolute evaluation data on the basis of the evaluation data and the value indicating the worth of the plurality of evaluators; and a recording step of recording the absolute evaluation data in a distributed ledger.

An information processing device according to a first aspect of the present technology includes: an acquisition unit that acquires, for a plurality of evaluators, evaluation data indicating evaluation of an evaluation target generated by the evaluator and a value indicating worth of the evaluator; a conversion unit that converts the evaluation data into absolute evaluation data on the basis of the evaluation data and the value indicating the worth of the plurality of evaluators; and a controller that performs control to record the absolute evaluation data in a distributed ledger.

In the first aspect of the present technology, evaluation data indicating evaluation of an evaluation target generated by the evaluator and a value indicating worth of the evaluator are acquired for a plurality of evaluators; the evaluation data is converted into absolute evaluation data on the basis of the evaluation data and the value indicating the worth of the plurality of evaluators; and the absolute evaluation data is recorded in a distributed ledger.

An information processing method or a program according to a second aspect of the present technology includes a step of, in a case where a distributed ledger is shared by a plurality of devices, the distributed ledger being formed by connecting blocks generated on the basis of a transaction storing learning data including identification information of a test provided by a test provider, learner information indicating a learner who has taken the test, and a score of the test of the learner, in response to reference to the learning data recorded in the distributed ledger, assigning a reference point to the test or the test provider providing the test indicated by the identification information included in the referenced learning data.

An information processing device according to the second aspect of the present technology is an information processing device that shares, with another device, a distributed ledger formed by connecting blocks generated on the basis of a transaction storing learning data including identification information of a test provided by a test provider, learner information indicating a learner who has taken the test, and a score of the test of the learner, the information processing device including a controller that, in response to reference to the learning data recorded in the distributed ledger, assigns a reference point to the test or the test provider providing the test indicated by the identification information included in the referenced learning data.

In the second aspect of the present technology, in a case where a distributed ledger is shared by a plurality of devices, the distributed ledger being formed by connecting blocks generated on the basis of a transaction storing learning data including identification information of a test provided by a test provider, learner information indicating a learner who has taken the test, and a score of the test of the learner, in response to reference to the learning data recorded in the distributed ledger, a reference point is assigned to the test or the test provider providing the test indicated by the identification information included in the referenced learning data.

### BRIEF DESCRIPTION OF DRAWINGS

FIG. 1 is a diagram for describing a blockchain platform.

FIG. 2 is a diagram for describing a configuration of a blockchain network.

FIG. 3 is a diagram for describing processing during execution of a transaction.

FIG. 4 is a diagram for describing an outline of the present technology.

FIG. 5 is a diagram illustrating a configuration example of a client.

FIG. 6 is a diagram illustrating a configuration example of a peer.

FIG. 7 is a diagram illustrating a configuration example of an analysis server.

FIG. 8 is a diagram illustrating a wallet managed by a client.

FIG. 9 is a flowchart for describing learning data registration application processing.

FIG. 10 is a diagram illustrating an example of a transaction.

FIG. 11 is a flowchart for describing reference point granting processing.

FIG. 12 is a diagram illustrating an example of a transaction.

FIG. 13 is a flowchart for describing learning data registration application processing.

FIG. 14 is a flowchart for describing reference point granting processing.

FIG. 15 is a diagram for describing a relationship between tests.

FIG. 16 is a diagram for describing calculation of an absolute score conversion rate.

FIG. 17 is a flowchart for describing absolute score calculation processing.

FIG. 18 is a flowchart for describing absolute score browsing processing and absolute score providing processing.

FIG. 19 is a diagram for describing nodes in a blockchain network.

FIG. 20 is a diagram illustrating a configuration example of a computer.

### MODE FOR CARRYING OUT THE INVENTION

Hereinafter, embodiments to which the present technology is applied will be described with reference to the drawings.

### First Embodiment

<Blockchain platform>

In a case where evaluation data indicating an evaluation result when an evaluation target is evaluated by a service or the like provided by an evaluator is recorded in a blockchain, the present technology converts each evaluation data into absolute evaluation data on the basis of the use value of a plurality of pieces of evaluation data different from one another, thereby enabling more reliable evaluation.

The use value of the evaluation data is determined by an evaluator, a service, or the like, and can be said to be a value regarding the evaluator, the service, or the like, that is, a use value.

Note that the evaluation data may be any data as long as the evaluation data indicates the evaluation for the evaluation target. Hereinafter, a case where the evaluation data is a score of a test provided by a test provider or the like as an evaluator will be described as an example.

Accordingly, in the example described below, the evaluation target is a learner (examinee) who takes a test provided by the test provider or the like, and the score of the test indicated by the evaluation data is converted into an absolute score by a conversion rate calculated on the basis of the use value of each test.

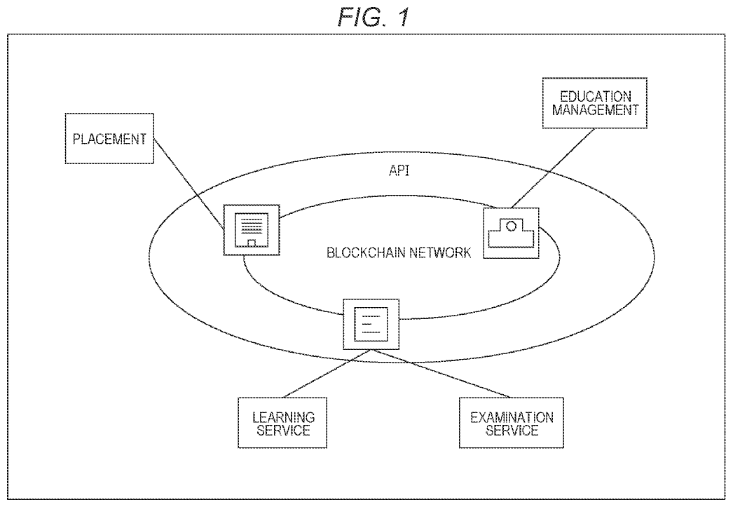

First, a blockchain platform will be described with reference to FIG. 1.

In the blockchain platform illustrated in FIG. 1, a school, a learner (student), a cram school, a placement service, various business operators, and the like store, share, and certify data regarding a history of learning and education, for example.

In the blockchain platform, each user such as a school or a learner connects to a blockchain network using an application programming interface (API), records data, and browses the recorded data.

For example, data regarding learning and education is generated as a result of providing an examination service (test), and the data is recorded in the blockchain network or the data is browsed and used for providing various services such as education management, learning service, and placement.

In the blockchain platform, by managing data regarding learning and education by a plurality of participants, falsification and the like of the data can be prevented, and highly reliable data can be shared in a safer manner.

Additionally, as the number of users of the blockchain network increases, more data is shared, so that a higher-quality service can be provided.

Here, the blockchain network will be described in more detail.

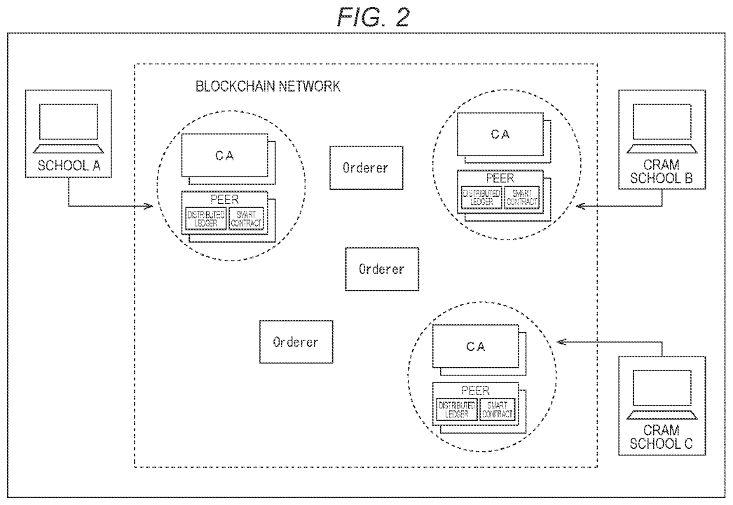

The blockchain network illustrated in FIG. 1 is configured as illustrated in FIG. 2, for example.

The blockchain network illustrated in FIG. 2 is a P2P network including a plurality of nodes managed by a plurality of participants, and is particularly referred to as a consortium-type blockchain network.

In this example, the blockchain network is managed by a school A, a cram school B, and a cram school C, which are participants. Note that the present invention is not limited to this example, and the blockchain network may be managed by any participant.

A blockchain network includes nodes functioning as a certificate authority (CA), a peer, and an orderer. The node here is an information processing device such as a server.

A CA is a node individually managed by a participant, and uses a mechanism referred to as a membership service provider (MSP) to register information regarding the participant, the peer, and the like, and issue a certificate to the participant, the peer, and the like.

A peer is a node individually managed by the participant, and records and reads data.

In particular, there are a peer referred to as an endorsement peer and a peer referred to as a committing peer.

An endorsement peer records a smart contract and a distributed ledger, and a committing peer records a distributed ledger.

Here, a smart contract is a program also referred to as a chain code, and by executing the smart contract, it is possible to automate processing of business logic agreed in advance between participants, such as reading and writing data under a predetermined condition.

Additionally, a distributed ledger includes a blockchain including a plurality of blocks and a state database.

A block included in the blockchain stores a plurality of transactions for requesting various types of processing such as reading and writing of data actually executed. Additionally, each block also stores a nonce value assigned to each of the blocks and a hash value generated for the immediately preceding block.

Accordingly, the blockchain can be said to be a database in which a plurality of blocks is connected in a chain by hash values.

For example, in a blockchain, if a transaction in a block is falsified, the hash value of the block changes. Hence, the blockchain cannot be locally falsified.

Additionally, in a state database of a distributed ledger, the latest state of the result of executing a transaction written in the blockchain is recorded.

Hereinafter, a distributed ledger including such a state database and a blockchain is also referred to as a blockchain database.

With respect to a block received from an orderer, the above-described committing peer verifies the transaction in the block, and writes the block into the blockchain database held by itself.

An endorsement peer is a peer that not only functions as a committing peer but also verifies and temporarily executes a transaction when the execution of the transaction is requested.

Additionally, an orderer included in the blockchain network is a node jointly managed by a plurality of participants, orders a plurality of transactions, packs the transactions into a block, and transmits the obtained block to a plurality of committing peers.

As described above, in the blockchain network illustrated in FIG. 2, there are CAs and peers managed by the school A, CAs and peers managed by the cram school B, CAs and peers managed by the cram school C, and orderers jointly managed by the school A, the cram school B, and the cram school C as nodes.

Note that there may be any number of CAs, peers, and orderers included in the blockchain network.

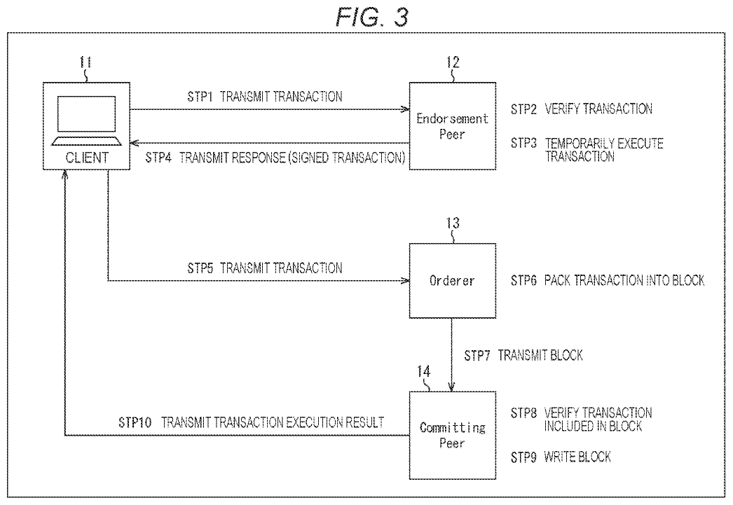

Next, a specific processing procedure when a transaction is executed and written to the blockchain will be described with reference to FIG. 3.

FIG. 3 illustrates a processing procedure when a client 11 connected to the blockchain network using the API requests execution of a transaction.

For example, the client 11 may be a device managed by a participant of the blockchain network such as the school A, the cram school B, or the cram school C illustrated in FIG. 2, or may be a device of a user or the like of a service provided in association with the blockchain network.

Here, a case where the cram school B is the owner of the client 11 and data of scores of a predetermined learner in a test as a service provided by the cram school B is written in the blockchain database will be described as an example.

In such a case, first, the client 11 generates a transaction that includes data indicating the score of the learner and requests (applies) to write the data to the blockchain database. The transaction also includes a signature of the client 11.

In procedure STP1, the client 11 transmits the generated transaction to a plurality of endorsement peers 12 using the API provided by the blockchain network.

Then, each endorsement peer 12 verifies the transaction received from the client 11 in procedure STP2.

Specifically, the endorsement peer 12 verifies whether the signature of the client 11 included in the transaction is genuine, and approves the transaction if it is confirmed that the signature is genuine.

When the transaction is approved, in procedure STP3, the endorsement peer 12 temporarily executes the transaction by executing the smart contract, and adds a signature of the endorsement peer 12 itself to the transaction.

Then, in procedure STP4, the endorsement peer 12 transmits the transaction to which its own signature is added to the client 11 as a response to procedure STP1.

Additionally, in procedure STP5, the client 11 transmits the transaction received as a response from the endorsement peer 12 to a plurality of orderers 13 using the API.

In the blockchain network, since not only the client 11 but also other clients apply for a transaction, a transaction is transmitted not only from the client 11 but also from other clients to the orderer 13.

Each orderer 13 receives and temporarily holds transactions transmitted from the client 11 and other clients.

In procedure STP6, the orderer 13 orders the plurality of transactions received from the client 11 and other clients, and packs (stores) the ordered plurality of transactions in one block.

At this time, the orderer 13 assigns a transaction ID that uniquely identifies each of a plurality of transactions to each of the plurality of transactions.

When a block is generated in this way, in procedure STP7, the orderer 13 transmits the generated block to a plurality of committing peers 14.

In procedure STP8, each of the committing peers 14 verifies each transaction included in the block received from the orderer 13.

For example, the committing peer 14 confirms, for each transaction, whether signatures of the endorsement peers 12 that satisfy a predetermined endorsement policy have been collected or the transaction has not been falsified.

When each transaction is verified, in procedure STP9, each of the committing peers 14 writes the block including each verified transaction to the blockchain database held by itself.

At this time, the committing peer 14 calculates a hash value of the last block included in the blockchain held by itself, and stores the hash value and a nonce value in the block to be newly written, thereby connecting the written block to the tail end of the blockchain.

As a result, the transaction temporarily executed in procedure STP3 is finally executed. Additionally, the committing peer 14 also updates the state database of the blockchain database held by itself according to the execution result of the transaction.

Finally, in procedure STP10, each of the committing peers 14 transmits the execution result of the transaction to the client 11.

The client 11 can grasp that the transaction applied (requested) by itself has been correctly executed by receiving the execution result of the transaction from the committing peer 14.

Note that while the processing procedure of the transaction for writing data has been described above, in the processing procedure of a transaction for reading (browsing) data, the processing from procedure STP1 to procedure STP4 described above is performed.

At this time, the response transmitted from the endorsement peer 12 to the client 11 in procedure STP4 includes data requested to be read by the client 11 by the transaction.

<Outline of present technology>

With the present technology, in a case where learning data of a learner is shared in the consortium-type blockchain network described above, more reliable evaluation can be performed by converting a score indicated by the learning data into an absolute score.

Hereinafter, the present technology will be described with reference to the drawings.

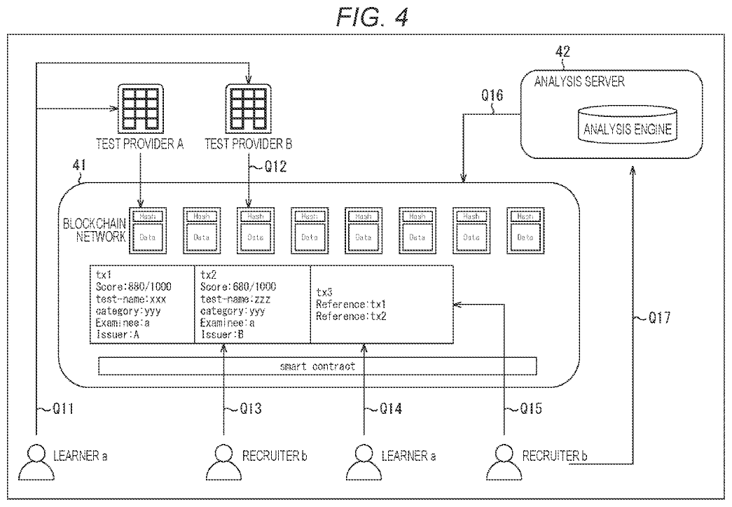

In the present technology, for example, as illustrated in FIG. 4, learning data of a learner is recorded in a blockchain database managed by a consortium-type blockchain network 41.

The blockchain database is the above-described distributed ledger including a blockchain and a state database, and is shared by a plurality of devices such as nodes included in the blockchain network 41.

In particular, in this example, the blockchain is configured by connecting a plurality of blocks generated on the basis of transactions in which learning data is stored, that is, a plurality of blocks including transactions.

The blockchain network 41 includes a plurality of nodes, and each of the nodes functions as the CA, the endorsement peer, the committing peer, and the orderer described above.

Here, the learning data recorded in the blockchain database is data indicating a score that is the result of a test (examination) provided by a test provider A or a test provider B that is a participant of the blockchain network 41.

Here, for example, the test provider A or the test provider B, which is a cram school or the like, performs a test of one or a plurality of categories, and each learner takes a test performed by the test provider A or the test provider B as indicated by an arrow Q11.

For example, assume that a predetermined learner a takes a test performed by the test provider A and a test performed by the test provider B.

Then, the test provider A and the test provider B generate learning data indicating the scores of the tests taken by the learner a, and record (register) the learning data in the blockchain database.

That is, for example, as indicated by an arrow Q12, the test provider B, more specifically, a client owned by the test provider B generates learning data indicating the score of the test taken by the learner a, and records (registers) the learning data in the blockchain database.

Specifically, the client generates a transaction including learning data and requesting recording of the learning data, and requests execution of the transaction, thereby recording the learning data (transaction) in the blockchain database.

Here, a transaction indicated by characters “tx2” is a transaction including the learning data indicating the test score of the learner a recorded (registered) by the test provider B.

For example, the transaction indicated by characters “tx2” includes a score indicated by characters “score: 680/1000”, a service ID indicated by characters “test-name: zzz”, a service category indicated by characters “category: yyy”, learner information indicated by characters “Examinee: a”, and examiner information indicated by characters “Issuer: B”.

A service ID is identification information indicating a service, and since a test is provided as a service here, each test (test name) can be identified by the service ID.

Additionally, learner information is information indicating a learner who has received provision of a service, that is, has taken a test, and examiner information is information indicating a provider of a service, that is, here, the test provider B.

Additionally, here, a transaction indicated by characters “tx1” is a transaction including the learning data indicating the test score of the learner a recorded by the test provider A.

By recording the learning data in this manner, for example, as indicated by an arrow Q13, an arbitrary user such as a school teacher or a recruiter b who is an employee of a placement service can access the blockchain database and browse (reference) the learning data.

For example, here, the recruiter b browses the learning data of the learner a, and evaluates the ability or the like of the learner a by looking at the score indicated by the learning data.

Additionally, for example, as indicated by an arrow Q14, instead of the test provider A or the test provider B, the learner a himself/herself can record, as learning data in the blockchain database, a collection of scores of a plurality of tests that the learner a has taken, like a learning history (hereinafter referred to as learning record summary).

Here, for example, a transaction indicated by characters “tx3” is a transaction including the learning data of the learning record summary of the learner a recorded by the learner a.

In particular, in this example, in the transaction indicated by characters “tx3”, characters “Reference: tx1” indicate a transaction ID of a referenced transaction included in the learning record summary, and similarly, characters “Reference: tx2” also indicate a transaction ID of a referenced transaction.

For example, characters “Reference: tx1” indicate that a transaction indicated by characters “tx1” is referenced, and characters “Reference: tx2” indicate that a transaction indicated by characters “tx2” is referenced.

Accordingly, in the transaction indicated by characters “tx3”, the learning record summary including the score of the test performed by the test provider A and the score of the test performed by the test provider B is stored as the learning data.

As indicated by an arrow Q15, the recruiter b can also browse learning data including such a learning record summary of the learner a and evaluate the ability or the like of the learner a by looking at each score of a plurality of tests indicated by the learning data.

Note that the summary of the learning record can be generated not only by the learner, but also by a school, a test provider, or the like.

As described above, the blockchain database records various learning data such as learning data indicating a score of a test performed by the test provider A, learning data indicating a score of a test performed by the test provider B, and learning data of a learning record summary.

However, for example, in a case where a test performed by a certain test provider is generally not widely recognized or a viewer such as the recruiter b does not have detailed knowledge about the test, it is difficult for the viewer to appropriately evaluate the ability or the like of the learner.

Additionally, for example, when the viewer compares scores of different tests with each other, he/she needs to have a certain experience and knowledge in order to determine which score indicates higher ability or the like from these scores.

Against this background, in the present technology, the score indicated by each learning data is converted into an absolute score, so that the viewer can more reliably evaluate the ability or the like of the learner on the basis of the absolute score.

In the conversion of the score of each test into the absolute score, the use value of each test, in other words, the reliability of the test or the test provider is expressed by reference points. That is, reference points are a value that indicates the use value of a test, more specifically, a score of the test provided by a test provider.

On the basis of the reference points of each test, an absolute score conversion rate that is a conversion rate for converting the score of each test into an absolute score is obtained.

Here, as an example, a test (service) having a higher frequency of browsing by the recruiter or the like, that is, a test having a larger number of times of browsing (number of times of reference) is regarded as a test having a higher use value to determine the reference points of each test. That is, the reference points of the test increases as the number of times of browsing increases.

For example, as indicated by an arrow Q13, assume that the recruiter b browses learning data indicating a score of a certain test of the test provider B taken by the learner a.

In such a case, in the blockchain network 41, the smart contract is executed, and a predetermined number of reference points are granted to the test of the test provider B in response to the browsing (referencing) of the learning data.

Additionally, for example, as indicated by an arrow Q15, when learning data of the learning record summary is browsed (referenced), too, reference points are granted for each test whose score is included in the learning record summary in response to the browsing of the learning record summary.

In this case, it is possible to identify which test score is included in the learning record summary from the referenced transaction ID included in the learning record summary.

Note that in a case where the same viewer browses the learning data of the same test a plurality of times, the reference points granted to the test may be reduced as the number of times of browsing increases, or granting of reference points may be omitted for the second and subsequent browsing. Alternatively, reference points may be granted when a viewer or the like performs an operation to give an instruction to grant reference points.

When reference points are granted to each test in this manner, the sum of the granted reference points is recorded in the blockchain database for each test.

In the example of FIG. 4, an absolute score conversion rate for converting a score of a test into an absolute score is obtained for each test on the basis of reference points of a plurality of tests belonging to the same category at an arbitrary timing.

In particular, in this example, the calculation of the absolute score conversion rate and the calculation of the absolute score are performed by an analysis server 42. The analysis server 42 may be a node such as an endorsement peer or a committing peer included in the blockchain network 41, or may be any client that is not a node, connected to the blockchain network 41.

For example, as indicated by an arrow Q16, the analysis server 42 reads, from the blockchain database at an arbitrary timing, reference points of each of a plurality of tests for each category and learning data including scores of these tests, more specifically, a transaction of the learning data.

Then, the analysis server 42 obtains the absolute score conversion rate on the basis of the read reference points and learning data, and converts the score indicated by the learning data into an absolute score by the absolute score conversion rate.

The analysis server 42 further generates absolute score data indicating the obtained absolute score, and holds the absolute score data by itself or writes the absolute score data in the blockchain database.

For example, absolute score data includes a score of a calculation source of the absolute score, that is, a transaction ID of a transaction storing learning data indicating a score before conversion into the absolute score, and the absolute score obtained by the conversion.

Additionally, for example, as indicated by an arrow Q15, assume that the recruiter b wants to know the absolute score of a score indicated by learning data after browsing predetermined learning data.

In such a case, for example, as indicated by an arrow Q17, the recruiter b can access the analysis server 42 by the client and browse (reference) the absolute score data.

Note that in a case where the absolute score data is also recorded in the blockchain database, the recruiter b can read the absolute score data from the blockchain database and browse the absolute score data.

### Client Configuration Example

Next, configurations of devices included in the blockchain network 41 illustrated in FIG. 4 and devices connected to the blockchain network 41 will be described.

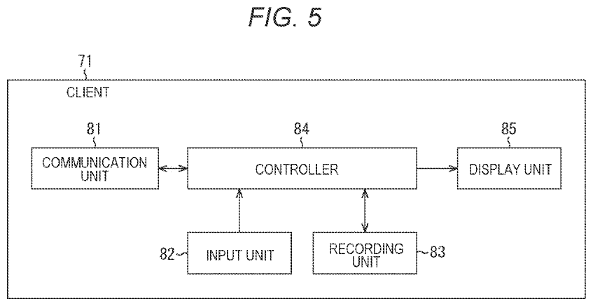

First, a client connected to the blockchain network 41 will be described. FIG. 5 is a diagram illustrating a configuration example of the client connected to the blockchain network 41.

A client 71 is, for example, an information terminal device such as a computer owned by each user connected to the blockchain network 41, such as the test provider A, the test provider B, the learner a, and the recruiter b illustrated in FIG. 4. Here, the description will be given assuming that the clients 71 of the users have the same configuration.

The client 71 includes a communication unit 81, an input unit 82, a recording unit 83, a controller 84, and a display unit 85.

The communication unit 81 communicates with, for example, nodes included in the blockchain network 41, the analysis server 42, and clients of other users, to receive various data and supply the data to the controller 84 or transmit data supplied from the controller 84.

The input unit 82 includes, for example, a mouse, a keyboard, a touch panel superimposed on the display unit 85, and the like, and supplies the controller 84 with a signal corresponding to a user's operation.

The recording unit 83 includes a nonvolatile memory or the like, and records data supplied from the controller 84 and supplies the recorded data to the controller 84.

The controller 84 controls the overall operation of the client 71. For example, in response to a signal from the input unit 82, the controller 84 supplies predetermined data to the communication unit 81 to transmit, or supplies data received by the communication unit 81 to the display unit 85 to display.

The display unit 85 includes, for example, a liquid crystal display panel or the like, and displays various images under the control of the controller 84.

### Peer Configuration Example

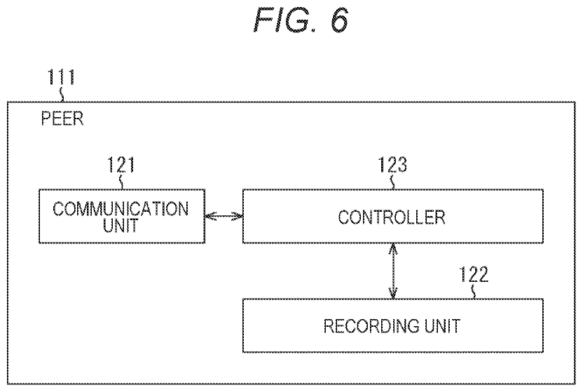

Additionally, a peer that is a node included in the blockchain network 41 is configured as illustrated in FIG. 6, for example.

A peer 111 illustrated in FIG. 6 functions as, for example, an endorsement peer or a committing peer. Hereinafter, it is assumed that the peer 111 functions as both an endorsement peer and a committing peer.

The peer 111 includes a communication unit 121, a recording unit 122, and a controller 123.

The communication unit 121 communicates with, for example, other nodes included in the blockchain network 41, the client 71, and the analysis server 42, to receive various data and supply the data to the controller 123 or transmit data supplied from the controller 123.

The recording unit 122 includes a nonvolatile memory or the like, and records the smart contract and the blockchain database described above.

Additionally, the recording unit 122 records data supplied from the controller 123 and supplies the recorded data to the controller 123.

The controller 123 controls the overall operation of the peer 111. For example, the controller 123 supplies predetermined data to the communication unit 121 to transmit, or supplies data received by the communication unit 121 to the recording unit 122 to record.

### Analysis Server Configuration Example

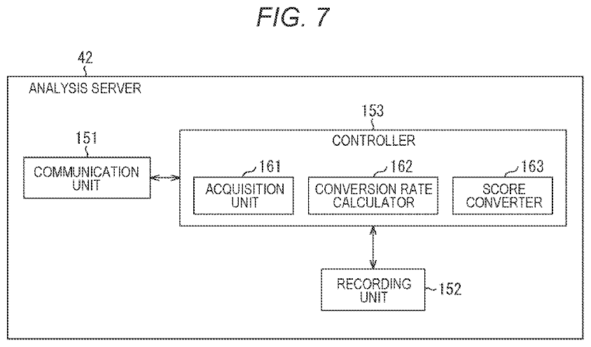

Moreover, the analysis server 42 illustrated in FIG. 4 has, for example, a configuration illustrated in FIG. 7.

The analysis server 42 includes a communication unit 151, a recording unit 152, and a controller 153.

The communication unit 151 communicates with, for example, nodes included in the blockchain network 41 and the client 71, to receive various data and supply the data to the controller 153 or transmit data supplied from the controller 153.

The recording unit 152 includes a nonvolatile memory or the like, and records data supplied from the controller 153 and supplies the recorded data to the controller 153.

The controller 153 controls the overall operation of the analysis server 42. For example, the controller 153 generates absolute score data on the basis of learning data and reference points supplied from the communication unit 151, and supplies the generated absolute score data to the recording unit 152 to record.

The controller 153 includes an acquisition unit 161, a conversion rate calculator 162, and a score converter 163.

The acquisition unit 161 controls the communication unit 151 to read a transaction or the like from the blockchain database, thereby acquiring (extracting) learning data and reference points from the blockchain database.

Note that in a case where the analysis server 42 also functions as the peer 111, since the blockchain database is recorded in the recording unit 152, the acquisition unit 161 can acquire learning data and reference points from the blockchain database recorded in the recording unit 152.

The conversion rate calculator 162 calculates an absolute score conversion rate on the basis of the learning data and reference points acquired by the acquisition unit 161.

The score converter 163 converts the score indicated by the learning data acquired by the acquisition unit 161 into an absolute score on the basis of the absolute score conversion rate, and generates absolute score data.

<Issuance of Certificate and Generation of Wallet>

Incidentally, in a case where an arbitrary user such as the test provider A or the learner a is to participate in the blockchain network 41, the user needs to access a CA included in the blockchain network 41 to issue a user ID and a certificate for identifying the user.

When the user ID and the certificate are issued by the CA, the user can be uniquely identified in the blockchain network 41, and the user can participate in the blockchain network 41.

As a specific example, a case where the test provider A participates in the blockchain network 41 by its own client 71 and provides predetermined tests A and B as services will be described, for example.

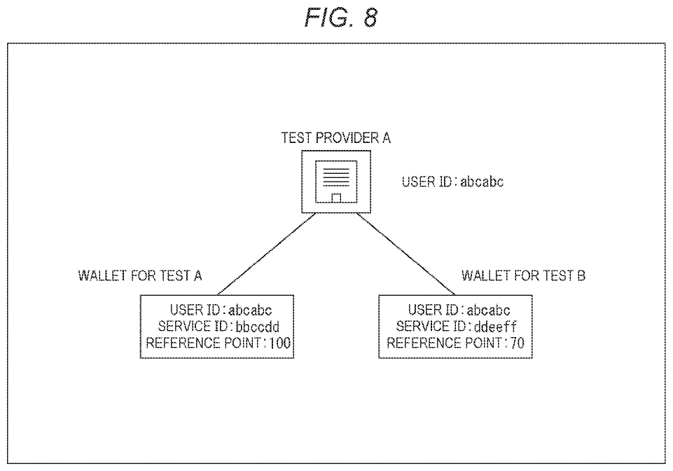

In this case, for example, as illustrated in FIG. 8, the client 71 of the test provider A accesses a CA of the blockchain network 41, and has the CA issue a user ID for identifying the test provider A (client 71) and a certificate of the test provider A.

At the same time, the client 71 of the test provider A also makes the CA issue a service ID, which is identification information for identifying a test A and a test B.

In the example of FIG. 8, a user ID “abcabc” of the test provider A, a service ID “bbccdd” for identifying the test A, and a service ID “ddeeff” for identifying the test B are issued.

The client 71 generates a wallet that records granted reference points for each test when a user ID, a certificate, and a service ID are issued.

In this example, the wallet of the test A includes the user ID “abcabc” of the test provider A, the service ID “bbccdd” of the test A, and the total number of reference points granted.

In this case, for example, when learning data including the score of any examinee of the test A performed by the test provider A is browsed, a reference point is granted to the test A, and the reference point granted to the wallet of the test A is recorded.

Similarly, a wallet of the test B includes the user ID “abcabc” of the test provider A, the service ID “ddeeff” of the test B, and the total number of reference points granted.

Note that while an example in which the reference point is granted for each test will be described here, the reference point may be granted for each test provider.

As described above, in the client 71 of a user providing a test as a service, such as the test provider A, a wallet is generated and the reference points are managed for each provided test.

In the client 71, a wallet generated by the controller 84, a user ID, a certificate, a service ID, and the like issued by a CA and received by the communication unit 81 are supplied from the controller 84 to the recording unit 83 and recorded.

Additionally, when a reference point is granted to a test, a transaction for granting the reference point is executed and recorded in the blockchain database, so that the blockchain network 41 can also identify the sum of reference points of each test.

<Description of Learning Data Registration Application Processing>

As described above, when each user receives a user ID and a certificate, as described with reference to FIG. 4, the user can record the learning data in the blockchain database or read and browse (reference) the learning data.

Hereinafter, operations such as writing and reading of learning data, granting of a reference point, and generation of absolute score data described with reference to FIG. 4 will be described in more detail.

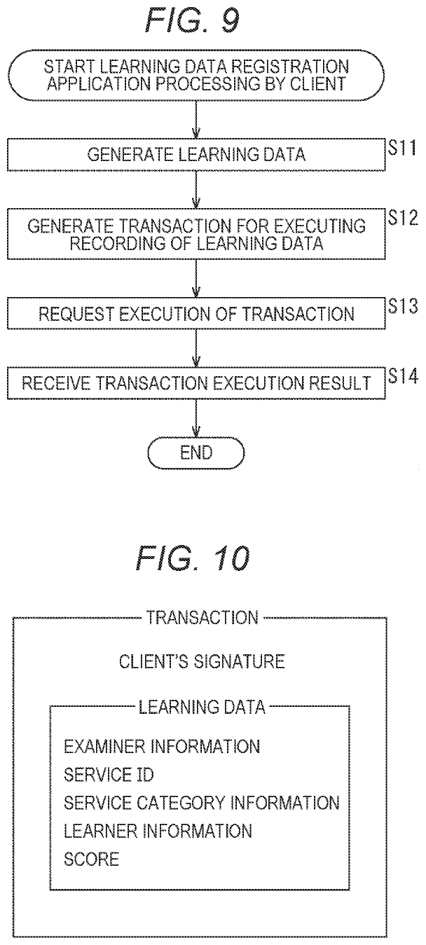

First, with reference to the flowchart of FIG. 9, processing performed when a user who performs a test, such as the test provider A, records learning data indicating a score of an examinee (learner) of the performed test in the blockchain database will be described.

That is, hereinafter, learning data registration application processing performed by the client 71 of the test provider will be described with reference to the flowchart of FIG. 9.

Note that, here, a case where the test provider A records learning data indicating a score of the learner a obtained as the execution result of the test A in the blockchain database will be described as an example.

Accordingly, here, the learning data registration application processing is processing similar to the processing indicated by the arrow Q12 in FIG. 4, and in this case, for example, a staff member or the like of the test provider A operates the input unit 82 to input the score of the learner a.

In step S11, the controller 84 appropriately reads necessary data from the recording unit 83 on the basis of a signal supplied from the input unit 82, and generates learning data indicating a score of the learner a.

Here, the learning data includes not only the score of the learner a but also information for enabling identification of the test A, the test provider A, and the like.

Specifically, for example, the learning data includes examiner information, a service ID, category information, learner information, and a score.

Examiner information is information indicating a provider of the test (service), that is, the test provider, and here, the examiner information is a user ID indicating the test provider A which is the provider of the test. Additionally, a service ID is a service ID indicating the test A which is the service.

Category information is information indicating a category of the test A, such as a public practice exam. Learner information is information indicating an examinee of the test A, and here, is a user ID or the like indicating the learner a.

In step S12, the controller 84 generates a transaction for executing recording of the learning data generated in step S11.

Here, for example, as illustrated in FIG. 10, the transaction includes the signature of the client 71 and the learning data generated in step S11.

Additionally, in this example, the learning data includes examiner information, a service ID, service category information, learner information, and a score.

The transaction generated in this manner requests recording of the learning data in the blockchain database (distributed ledger).

Note that the signature of the client 71 stored in the transaction is generated on the basis of a certificate issued for the client 71 by the CA of the blockchain network 41.

Returning to the description of the flowchart of FIG. 9, in step S13, the controller 84 requests execution of the transaction generated in step S12. That is, registration application of the transaction to the blockchain network 41 is performed.

Specifically, the controller 84 supplies the transaction to the communication unit 81 and gives an instruction on transmission (broadcasting) of the transaction to the plurality of peers 111 of the blockchain network 41.

Then, the communication unit 81, the controller 84, and the nodes of the blockchain network 41 perform processing similar to procedures STP1 to STP10 described with reference to FIG. 3, and the transaction is recorded in the blockchain database.

In this case, the client 71 corresponds to the client 11 in FIG. 3, and the peer 111 corresponds to the endorsement peer 12 and the committing peer 14.

Additionally, in the processing corresponding to procedure STP3, the signature of the peer 111 is added to the transaction illustrated in FIG. 10, and further, in the processing corresponding to procedure STP6, a transaction ID is assigned to the transaction by an orderer.

Moreover, when the transaction illustrated in FIG. 10 to which the signature of the peer 111 and the transaction ID are added is recorded in the blockchain database in the recording unit 122 of the peer 111, the execution result of the transaction is transmitted to the client 71 in the processing corresponding to procedure STP10.

In step S14, the communication unit 81 receives the execution result of the transaction transmitted from the peer 111 functioning as the committing peer, and supplies the transaction execution result to the controller 84.

Then, the controller 84 supplies the execution result of the transaction supplied from the communication unit 81 to the display unit 85 to display, and the learning data registration application processing ends.

As described above, the client 71 generates a transaction including learning data indicating a score of a learner and requests execution of the transaction, thereby recording the learning data in the blockchain database.

As a result, participants of the blockchain network 41 can freely browse the written learning data.

<Description of Reference Point Granting Processing>

Additionally, for example, assume that an arbitrary participant such as the recruiter b accesses the blockchain network 41 by the client 71 owned by the recruiter b, and browses (references) learning data, more specifically, a transaction including the learning data recorded in the blockchain database.

In such a case, processing similar to the procedures STP1 to STP4 described with reference to FIG. 3 is performed by the client 71 and the nodes of the blockchain network 41.

At this time, the client 71 corresponds to the client 11. Then, in the processing corresponding to procedure STP1, the client 71 transmits a transaction including a transaction ID of a transaction including the learning data to be browsed and requesting reading of the transaction indicated by the transaction ID.

Thereafter, in the processing corresponding to procedure STP3, the smart contract is executed, and the learning data requested to be read, more specifically, the transaction indicated by the transaction ID is read.

Additionally, in the processing corresponding to procedure STP4, the read transaction, that is, the learning data requested to be read is transmitted to the client 71 as a response to the transaction transmitted in the processing corresponding to procedure STP1.

Moreover, when the processing corresponding to procedure STP3 is performed, the peer 111 functioning as an endorsement peer newly generates a transaction for recording browsing of the learning data, that is, for recording a browsing history of the learning data, and records the transaction in the blockchain database.

In this case, the transaction generated by the peer 111 includes, for example, at least a transaction ID of the transaction storing the browsed (read) learning data and a user ID of the viewer who has browsed the learning data.

When a new transaction is generated by the peer 111 in this manner, thereafter, processing corresponding to procedures STP5 to STP10 or processing corresponding to procedures STP1 to STP10 described with reference to FIG. 3 is performed, and the new transaction is recorded in the blockchain database. At this time, the peer 111 that has generated the new transaction corresponds to the client 11 in FIG. 3, and each processing is performed.

Moreover, in a case where the learning data registration application processing described with reference to FIG. 9 is performed as described above and the learning data recorded as a result is browsed by a third party such as the recruiter b, the smart contract is executed in the processing corresponding to procedure STP3.

At this time, a transaction for recording the browsing history is newly generated, and at the same time, the peer 111 which is an endorsement peer executes the smart contract, thereby performing reference point granting processing of granting a reference point as necessary.

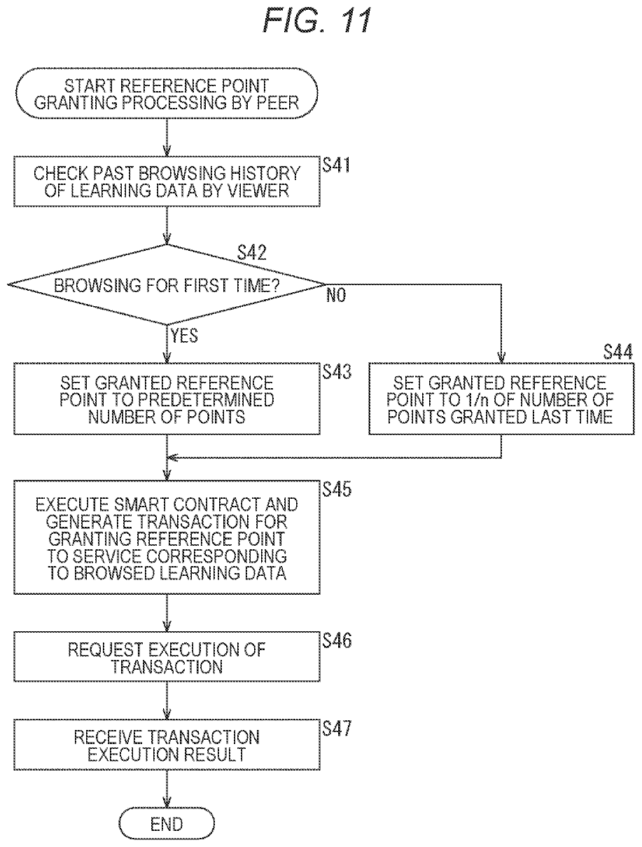

Hereinafter, the reference point granting processing performed by the peer 111 will be described with reference to the flowchart of FIG. 11.

Note that, here, description will be given on the assumption that the learning data indicating the score of the test A of the learner a recorded by the learning data registration application processing described with reference to FIG. 9 has been browsed by the recruiter b.

In step S41, the controller 123 checks the past browsing history of the learning data by the viewer.

Specifically, the controller 123 checks the past browsing history by searching for a transaction for recording the browsing history of the learning data indicating the score of the test A by the client 71 of the recruiter b from the blockchain database recorded in the recording unit 122.

In this case, the test of the browsed learning data and the viewer thereof can be identified by the service ID included in the referenced transaction indicated by the transaction ID included in the browsing history transaction, and the user ID indicating the viewer included in the browsing history transaction.

At the time of checking the browsing history, the controller 123 checks whether or not the client 71 of the recruiter b has browsed learning data indicating a score of the test A of any learner, not limited to the learner a, in the past.

In step S42, the controller 123 determines whether or not this is the first time for the recruiter b who is the viewer to browse the learning data indicating a score of the test A. Note that, in step S42, it may be determined whether or not it is the first time for the recruiter b to browse the learning data indicating the score of the learner a of the test A.

If it is determined in step S42 that this is browsing for the first time, in step S43, the controller 123 sets the reference point granted to the test A this time to a predetermined number of points (e.g., N points), and thereafter, the processing proceeds to step S45.

On the other hand, if it is determined in step S42 that this is not browsing for the first time, in step S44, the controller 123 sets the reference point granted to the test A this time to 1/n of the number of points granted to the test A last time. The number of reference points granted to the test A last time can be identified by browsing (referencing) a transaction for granting the reference points.

After the processing of step S44 is performed, the processing proceeds to step S45.

Note that in a case where the same viewer browses the learning data of the same test a plurality of times, granting of new reference points to the test may be omitted for the second and subsequent browsing.

In such a case, no reference point is granted to the test A in step S44, and the reference point granting processing ends.

In any case, if the same viewer browses the learning data of the same test a plurality of times, the reference point granted to the test in step S44 decreases as the number of times of browsing (number of times of reference) of the learning data of the test increases.

As described above, when an arbitrary viewer browses learning data indicating a score of a test, a reference point is granted to the test. As a result, the total of the granted reference points increases for a test with a large number of viewers, in other words, a test with a large number of times of browsing.

Accordingly, it can be said that a test with a large total of granted reference points is a test that is widely known or used as a criterion for evaluation, and thus such a test can be said to be a test with high use value, that is, with high reliability. In the present technology, the use value of a test (test provider) is expressed by the reference point.

When the processing in step S43 or step S44 is performed, in step S45, the controller 123 executes the smart contract and generates a transaction for granting a reference point to a service corresponding to the browsed learning data, that is, the test A.

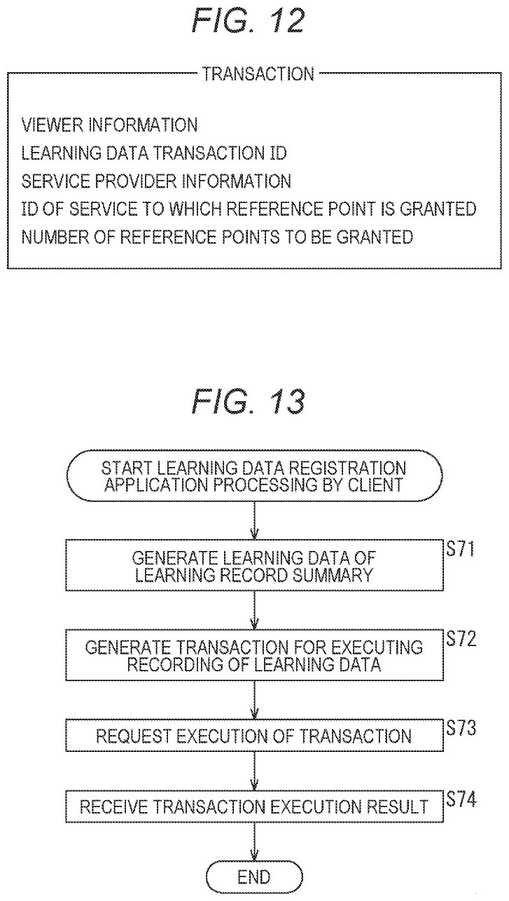

Specifically, for example, as illustrated in FIG. 12, a transaction including viewer information, a transaction ID of a transaction including the browsed learning data, service provider information, a service ID, and the number of reference points to be granted is generated.

The viewer information here is information indicating a viewer of the learning data, and is, for example, a user ID indicating the recruiter b who is the viewer.

Additionally, service provider information is information indicating a provider of a service to which a reference point is granted, and is, here, a user ID or the like of the test provider A who is the provider of the test A.

Moreover, the service ID here is a service ID indicating the test A to which a reference point is granted, and the number of reference points is the number of points determined in step S43 or step S44.

Such a transaction for granting a reference point can also be used as a browsing history of learning data after recording in the blockchain database. Accordingly, for example, in step S41, it is possible to check the past browsing history by referencing a transaction for granting a reference point generated in the past.

Returning to the description of the flowchart of FIG. 11, in step S46, the controller 123 requests execution of the transaction generated in the processing of step S45.

That is, the controller 123 supplies the transaction for granting a reference point to the communication unit 121, and gives an instruction on transmission to an endorsement peer included in the blockchain network 41.

Then, under the control of the controller 123, the communication unit 121 transmits (broadcasts) the transaction supplied from the controller 123 to a plurality of endorsement peers.

This processing corresponds to procedure STP1 described with reference to FIG. 3, and thereafter, the processing of procedure STP2 to procedure STP10 described with reference to FIG. 3 is performed by the peer 111, the endorsement peer, the orderer, and the committing peer. In this case, the peer 111 corresponds to the client 11 of FIG. 3.

For example, when the processing of procedure STP9 is performed and the block in which the transaction is stored is written to the blockchain database (distributed ledger), the sum of the reference points assigned to the test A recorded in the state database is also updated.

Additionally, when the transaction is executed, the reference point granted this time is transmitted to the client 71 of the test provider A who is the provider of the test A.

In the client 71, when the transmitted reference point, that is, the executed transaction is received, the wallet of the test A recorded in the recording unit 83 is updated by the controller 84.

When the processing of procedure STP10 is further performed, an execution result of the transaction requested to be executed in step S46 is transmitted from the committing peer to the peer 111.

In step S47, the communication unit 121 receives the transaction execution result transmitted from the committing peer and supplies the transaction execution result to the controller 123.

By receiving the supply of the transaction execution result from the communication unit 121, the controller 123 can recognize that the transaction is reliably executed and the reference point is granted to the service A. When the transaction execution result is received in this manner, the reference point granting processing ends.

As described above, when learning data is browsed by an arbitrary viewer, the peer 111 grants a reference point to a service (test) corresponding to the learning data according to the browsing state of the learning data, that is, the number of times of browsing so far.

In this way, the use value of each test can be represented by the reference point according to the actual browsing state. Thus, an appropriate absolute score conversion rate can be obtained using the reference point, and as a result, more reliable evaluation can be performed for each learning data.

Additionally, by referencing the blockchain database, the viewer can view the total value of the reference points of each test. Such a reference point can also be used as the use value, that is, the reliability of a test or a test provider.

For example, a certain viewer may want to evaluate one or more learners, but there is a plurality of tests belonging to the same category, and the viewer may not know which test should be used as a criterion for the evaluation.

In such a case, the viewer can evaluate the ability of each learner on the basis of the absolute score, and can also perform appropriate evaluation by, for example, evaluating the ability of each learner by a score of a test with a high reference point, that is, a test with a high use value.

<Description of Registration Application Processing of Learning Data of Learning Record Summary>

Note that in the above description, the case has been described in which a test provider records learning data in the blockchain database and a viewer browses the learning data.

However, for example, as indicated by an arrow Q14 in FIG. 4, in a case where a learner or the like records learning data of a learning record summary in the blockchain database and a viewer browses the learning data, too, processing similar to the processing described with reference to FIGS. 9 and 11 is performed.

Hereinafter, processing in which learning data of a learning record summary is recorded, and the learning data is browsed and a reference point is granted will be described.

First, learning data registration application processing performed by the client 71 owned by the learner will be described with reference to the flowchart of FIG. 13.

Note that, here, a case where the learner a illustrated in FIG. 4 generates learning data of a learning record summary including scores of the test A and the test B will be described as an example. In this case, the learner a operates the input unit 82 of the client 71 to input the scores of the test A and the test B or give an instruction on generation of the learning data.

In step S71, the controller 84 generates the learning data of the learning record summary on the basis of a signal corresponding to the operation of the learner a supplied from the input unit 82.

Here, for example, learning data including a transaction ID of a transaction including learning data indicating a score of the test A of the learner a and a transaction ID of a transaction including learning data indicating a score of the test B of the learner a is generated as learning data of the learning record summary.

That is, learning data of a learning record summary includes, as information indicating a transaction to be referenced, a transaction ID of a transaction storing learning data indicating a score of each test.

Note that hereinafter, a transaction to be referenced indicated by a transaction ID included in learning data of a learning record summary is also referred to as a referenced transaction.

In step S72, the controller 84 generates a transaction for executing recording of the learning data generated in step S71.

Here, for example, a transaction including a signature of the client 71 and the learning data generated in step S71 is generated.

When the transaction is generated in this manner, the processing of steps S73 and S74 is then performed and the learning data registration application processing ends. Since the processing is similar to the processing of steps S13 and S14 of FIG. 9, the description thereof will be omitted.

As described above, the client 71 generates a transaction including the learning data of the learning record summary and requests execution of the transaction, thereby recording the learning data in the blockchain database.

As a result, participants of the blockchain network 41 can freely browse the written learning data.

<Description of Reference Point Granting Processing at Time of Browsing Learning Record Summary>

Additionally, in a case where learning data of a learning record summary recorded in the blockchain database is browsed by the processing described with reference to FIG. 13, too, a reference point is assigned to each test, similarly to the case described with reference to FIG. 11.

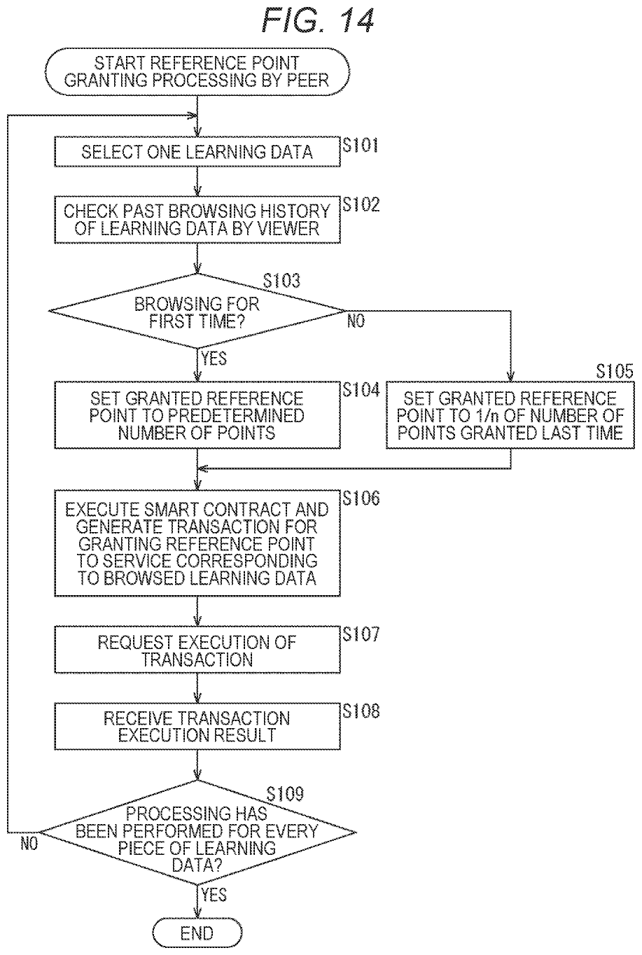

Hereinafter, reference point granting processing performed by the peer 111 when the learning data of the learning record summary is browsed will be described with reference to the flowchart of FIG. 14.

In step S101, the controller 123 selects one learning data to be processed from among learning data included in a plurality of referenced transactions referenced by the browsed learning data of the learning record summary.

When the learning data to be processed is selected, processing of steps S102 to S108 is then performed, and a reference point is granted to a test (service) of a score included in the learning data to be processed.

Note that the processing of steps S102 to S108 is similar to the processing of steps S41 to S47 of FIG. 11, and the description thereof will be omitted.

In step S109, the controller 123 determines whether or not the above processing in steps S101 to S108 has been performed on the learning data included in all the referenced transactions, that is, every piece of learning data.

If it is determined in step S109 that the processing has not been performed on every piece of learning data, the processing returns to step S101, and the above-described processing is repeated.

On the other hand, if it is determined in step S109 that the processing has been performed on every piece of learning data, the reference point granting processing ends.

As described above, when the learning data of the learning record summary is browsed, the peer 111 grants a reference point for each test summarized by the learning data.

In this way, similarly to the time of browsing learning data indicating a score of a single test, a reference point corresponding to the browsing state can be granted to each browsed test. As a result, an appropriate absolute score conversion rate can be obtained using the reference point, and more reliable evaluation can be performed.

<Calculation of Absolute Score Conversion Rate>

Next, calculation of the absolute score conversion rate used to convert the score of each test (service) into an absolute score on the basis of the reference point obtained for each test will be described.

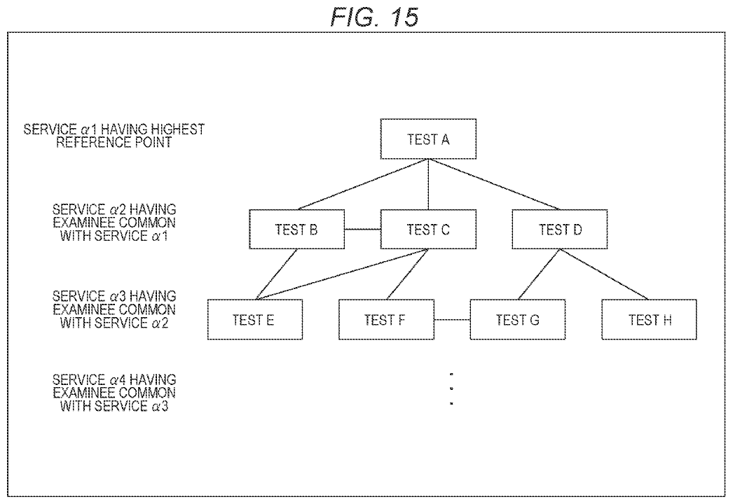

For example, the tests have a relationship as illustrated in FIG. 15 depending on the sum of the reference points granted to the tests and whether or not there is a common examinee (learner) between the tests.

In the example illustrated in FIG. 15, each quadrangle represents a test (service), and a straight line connecting two quadrangles represents that the two tests connected by the straight line have a common examinee.

Additionally, in this example, a plurality of tests is hierarchically classified into a plurality of services such as service α1, service α2, service α3, service α4, and so on.

Specifically, among all tests (services), the test A having the highest sum of reference points is set as the service α1, and the test having an examinee common with the test A which is the service α1 is set as the service α2.

Here, the test B, a test C, and a test D are classified as the service α2, and the tests are taken by the same examinee as the service A. Additionally, it can be seen that there is a common examinee between the service B and the service C classified as the same service α2.

Additionally, the test classified as the service α3 is a test having an examinee common with any test classified as the service α2, and here, a test E, a test F, a test G, and a test H are classified as the service α3.

The test classified as the service α3 does not have an examinee in common with the test of the service α1. However, since the test classified as the service α3 has an examinee common with a test of the service α2 having an examinee common with the service α1, the test is indirectly related to the service α1.

Moreover, a test having an examinee common with a test classified as the service α3 is classified as the service α4, and the rest of the tests are further classified so that all tests belong to a service of a hierarchy.

In the analysis server 42, the absolute score conversion rate is calculated using the relationship among tests as illustrated in FIG. 15, that is, the hierarchical classification result of the services.

Specifically, in calculating the absolute score conversion rate, first, a score conversion rate of the score between individual tests is calculated.

For example, a test classified as the service α1 is set as a reference test, and for all tests other than the reference test, a score conversion rate for converting the score of the test into a score based on the reference test, that is, a score corresponding to the reference test (score corresponding to score of reference test) is calculated.

Note that the tests for which the score conversion rate are calculated are tests belonging to the same category indicated by category information.

Here, since the service α1 having the highest total of reference points is the test A, a specific description will be given by exemplifying a case where a score conversion rate for converting scores of tests other than the test A into scores based on the test A is calculated.

First, learning data indicating the score of each test recorded in the blockchain database is extracted, and the score of the test indicated by each learning data is normalized so as to be a score on a scale of 100, that is, a score with a maximum score of 100 points.

For example, assuming that the test B has a maximum point of 990 points and the score of the test B of a certain examinee (learner) is X, the score is normalized by performing the calculation of X/990×100. Hereinafter, the score thus normalized is also referred to as a normalized score.

Next, for each test classified as the service α2 having an examinee common with the test A, which is a reference test, the score conversion rate of the test based on the test A is calculated.

Here, for example, a case where the score conversion rate of the test B based on the test A is calculated will be described as an example.

In this case, the normalized scores of the test A and the normalized scores of the test B are extracted for all examinees who have taken both the test A and the test B.

Then, the sum of the normalized scores of the test A of all the examinees and the sum of the normalized scores of the test B of all the examinees are obtained, and the ratio of the sum of these normalized scores is obtained as the score conversion rate. Note that, here, in order to simplify the description, it is assumed that the number of times each of the examinees takes the test A and the test B is the same.

For example, assuming that the sum of the normalized scores of the test A is 386 and the sum of the normalized scores of the test B is 582 for all the examinees, that is, the examinees who have taken both the test A and the test B, the score conversion rate of the test B based on the test A is 386/582.

Accordingly, if the score of the test B of a certain examinee is X1, the score based on the test A, that is, the score corresponding to the test A of the score X1 is X1×386/582. The score conversion rate obtained in this manner is a conversion rate when the score of the test B is simply converted into a score based on the test A without considering the reference point.

Next, for each test classified as the service α3 that does not have an examinee common with the test A that is the reference test but has an examinee common to the test classified as the service α2, the score conversion rate of the test based on the test A is calculated.

Here, for example, a case where the score conversion rate of the test E based on the test A is calculated when the test B classified as the service α2 and the test E classified as the service α3 have a common examinee will be described as an example.

In this case, the normalized scores of the test B and the normalized scores of the test E are extracted for all examinees who have taken both the test B and the test E.

Then, the sum of the normalized scores of the test B of all the examinees and the sum of the normalized scores of the test E of all the examinees are obtained, and the ratio of the sum of these normalized scores is obtained as the score conversion rate of the test E based on the test B.

For example, assuming that the sum of the normalized scores of the test B is 402 and the sum of the normalized scores of the test E is 502 for all the examinees, that is, the examinees who have taken both the test B and the test E, the score conversion rate of the test E based on the test B is 402/502.

Additionally, assuming that the score conversion rate of the test B based on the test A is 386/582, the score conversion rate of the test E based on the test A can be obtained from the score conversion rate of the test B based on the test A and the score conversion rate of the test E based on the test B.

That is, in this example, the score conversion rate (386/582)×(402/502) of the test E based on the test A can be obtained from the score conversion rate 386/582 of the test B based on the test A and the score conversion rate 402/502 of the test E based on the test B.

Accordingly, if the score of the test E of a certain examinee is X2, the score based on the test A, that is, the score corresponding to the test A of the score X2 is X2×(386/582)×(402/502).

Moreover, similarly to the example described above, for all tests classified into hierarchies such as the service α4, the score conversion rates of the tests based on the test A (reference test) are calculated.

Additionally, when the score conversion rate of each test when the test A having the highest reference point is used as the reference test is obtained, similarly, for the top m tests having high reference points including the test A, the score conversion rate of each test when these tests are used as the reference test is calculated. Note that the number m here is a predetermined number, and for example, the number m may be the number of all tests.

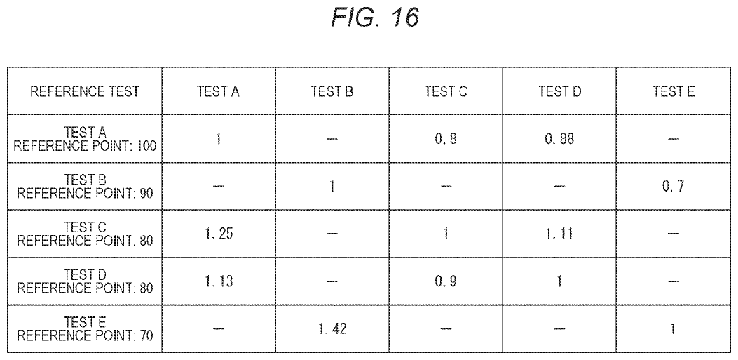

With the processing described above, for example, as illustrated in FIG. 16, assume that the score conversion rate of each test when each test of the top m tests (m=5 in this case) with high reference points is used as the reference test is obtained.

Note that in the example of FIG. 16, fields of tests arranged in the vertical direction in the drawing indicate reference tests, and fields of tests arranged in the horizontal direction in the drawing indicate tests whose scores are to be converted, that is, tests as conversion targets.

Accordingly, for example, a score conversion rate “1.25” obtained for the reference “test C” and the conversion target “test A” indicates a score conversion rate for converting the score of the test A into a score based on the test C, that is, a score corresponding to the test C.

Additionally, for example, the score conversion rate obtained for the reference “test A” and the conversion target “test A” is “1”. Moreover, “−” written in the field of the score conversion rate indicates that the score conversion rate cannot be obtained because the reference test and the conversion target test have no direct or indirect relationship.

In a case where such score conversion rates illustrated in FIG. 16 are obtained, the analysis server 42 obtains the absolute score conversion rate as follows.

Here, as a specific example, a case of obtaining the absolute score conversion rate for converting the score of the test A into an absolute score will be described.

In such a case, the score conversion rate of the test A obtained for each of the reference tests is subjected to weighted summing using the reference point granted to each of the reference tests as a weight, and the weighted average value obtained as a result is taken as the absolute score conversion rate.

Specifically, here, the score conversion rate “1” of the reference test A and the reference point “100” of the reference test A, the score conversion rate “1.25” of the reference test C and the reference point “80” of the reference test C, and the score conversion rate “1.13” of the reference test D and the reference point “80” of the reference test D are extracted. Additionally, in this example, the sum of the reference points of the reference tests is 260 (=100+80+80).

Accordingly, from these score conversion rates and the reference points, (1×100+1.25×80+1.13×80)/260=1.12 is calculated, and the absolute score conversion rate “1.12” of the test A is obtained.

By multiplying the normalized score of the test A by the absolute score conversion rate thus obtained, the score of the test A can be converted into an absolute score.

For example, in a case where the test A has a maximum point of 990 points and the score of the test A of a certain learner is 700 points, the absolute score of the score “700” is 79 points (79=(700/990)×100×1.12).

As described above, if the absolute score conversion rate is obtained in consideration of the reference point, that is, the use value of the test, at the time of conversion into the absolute score, conversion with more importance placed on the test with high use value is performed.

In other words, the higher the use value of the test, the higher the contribution rate to the absolute score as an evaluation criterion, and the absolute score in which the use value of each test is taken into consideration can be obtained.

Accordingly, if the viewer (evaluator) uses the absolute score, it is possible to perform absolute evaluation of the ability of each learner with an evaluation criterion close to a test having a higher use value. As a result, it is possible to perform more reliable evaluation.

As an example, in a case where the test A is generally widely known and the reference point of the test A is high, for example, since the absolute score is close to a score based on the test A, the viewer can perform more intuitive and more reliable evaluation on the basis of the absolute score.

Note that the absolute score conversion method described herein is merely an example, and any absolute score conversion method may be used as long as the scores of the tests can be converted into absolute scores of the same evaluation criterion.

<Description of Absolute Score Calculation Processing>

In the analysis server 42, as described above, the absolute score conversion rate is obtained for each test, and a score indicated by learning data is converted into an absolute score to generate absolute score data.

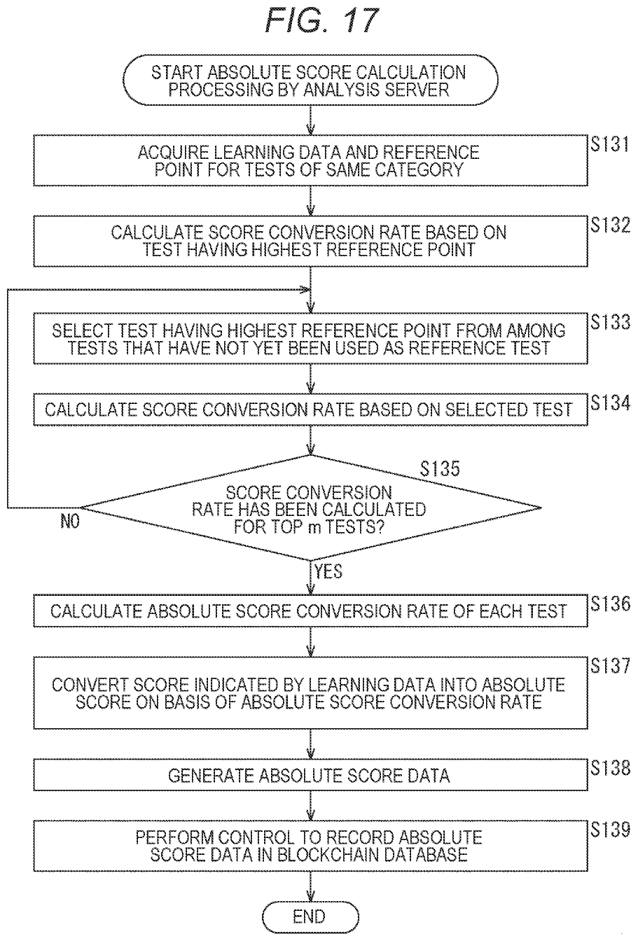

Here, absolute score calculation processing performed by the analysis server 42 will be described with reference to the flowchart of FIG. 17.

Note that the absolute score calculation processing may be performed at any timing such as a periodic timing, a timing when a reference point is granted to any test, or a timing when there is a request from the client 71 to browse absolute score data.

Additionally, here, the description will be given on the assumption that the analysis server 42 also functions as the peer 111 and the blockchain database is recorded in the recording unit 152.

In step S131, the acquisition unit 161 acquires (extracts) learning data indicating scores of tests belonging to the same category and reference points of the tests from the blockchain database recorded in the recording unit 152.

For example, the category of each test can be identified by category information included in the learning data.

Additionally, the reference point of each test can be obtained from transactions of reference point granting executed in the reference point granting processing of FIGS. 11 and 14 recorded in the blockchain, and information indicating the result of executing these transactions recorded in the state database.

Note that in a case where the analysis server 42 does not have a function as the peer 111, the acquisition unit 161 generates a transaction requesting browsing (reference) of a transaction storing necessary information such as learning data and reference points, and controls the communication unit 151 to transmit the transaction to thereby read the transaction or the like.

Then, the acquisition unit 161 extracts (acquires) necessary learning data and reference points from the read transaction. In this case, the analysis server 42 serves as the client 11 in FIG. 3, processing of procedures STP1 to STP4 is performed, and a necessary transaction or the like is read.

In step S132, the conversion rate calculator 162 uses a test having the highest reference point, that is, the test classified as the service α1 described above, as a reference test, and calculates a score conversion rate based on the reference test.

For example, assuming that the test classified as the service α1 is the test A, as described with reference to FIG. 15, using the test A as a reference test, the conversion rate calculator 162 calculates a score conversion rate for converting the scores of the tests into scores based on the test A for all the other tests.

In step S133, the conversion rate calculator 162 selects a test having the highest reference point as a reference test from among tests that have not yet been used as a reference test among the plurality of tests.

In step S134, the conversion rate calculator 162 performs processing similar to the case in step S132 to calculate a score conversion rate based on the reference test selected in step S133.

In step S135, the conversion rate calculator 162 determines whether or not the score conversion rate has been calculated for the top m tests among the plurality of tests, using each of the m tests as a reference test.

If it is determined in step S135 that the score conversion rate has not yet been calculated by using the top m tests as reference tests, the processing returns to step S133, and the above-described processing is repeated.

On the other hand, if it is determined in step S135 that the score conversion rate has been calculated using the top m tests as reference tests, the processing proceeds to step S136. In this case, for example, as illustrated in FIG. 16, when each of the top m tests with high reference points is used as the reference test, the score conversion rates of other tests are obtained.

In step S136, the conversion rate calculator 162 calculates the absolute score conversion rate of each test on the basis of the score conversion rate of each test calculated for each reference test.

That is, as described with reference to FIG. 16, for each test, the conversion rate calculator 162 calculates the absolute score conversion rate by obtaining a weighted average value of the score conversion rates when the reference points of the reference tests are used as weights and the reference tests are used as references.

In step S137, the score converter 163 converts the score indicated by the learning data into an absolute score on the basis of the absolute score conversion rate for each learning data acquired in step S131.

In step S138, the score converter 163 generates absolute score data by associating the obtained absolute score with the transaction ID of the transaction storing the learning data indicating the original score before the conversion of the absolute score.

In step S139, the controller 153 performs control to record the absolute score data obtained in step S138 in the blockchain database.

That is, for example, the controller 153 generates a transaction requesting recording of the absolute score data and supplies the transaction to the communication unit 151.

Then, the controller 153 controls the communication unit 151 to transmit the transaction to an endorsement peer included in the blockchain network 41, thereby requesting execution of the transaction.

Then, processing corresponding to procedures STP1 to STP10 described with reference to FIG. 3 is performed among the analysis server 42 and the endorsement peer, the orderer, and the committing peer included in the blockchain network 41, and the absolute score data is recorded in the blockchain database.

Note that the controller 153 may also perform control to record the absolute score data in an area other than the blockchain database of the recording unit 152, or the absolute score data may be recorded only in the recording unit 152 and not recorded in the blockchain database.

Additionally, in a case where the administrator of the analysis server 42 is an administrator (consortium member) of the blockchain network 41 such as the test provider A or the test provider B, the analysis server 42 can have a function as the peer 111.

In such a case, the analysis server 42 can read learning data and reference points from the blockchain database recorded by itself in step S131, and can record the absolute score data in the blockchain database recorded by itself in step S139. Additionally, in this case, a program for providing a service using the blockchain network 41 executed by the analysis server 42 is provided by, for example, an administrator (consortium member) of the blockchain network 41.

On the other hand, in a case where the analysis server 42 does not have a function as the peer 111, the analysis server 42 itself does not have the blockchain database.

Hence, the analysis server 42 reads learning data and reference points from the blockchain database held by the peer 111 (node) by exchanging transactions with the peer 111 using the API in step S131, for example.

Additionally, the analysis server 42 requests recording of the absolute score data in the blockchain database held by the peer 111 by exchanging transactions with a node such as the peer 111 using the API in step S139, for example. Additionally, in this case, the program for providing a service using the blockchain network 41 executed by the analysis server 42 may be provided by an administrator of the blockchain network 41 or may be developed by an administrator of the analysis server 42, for example.

When the absolute score data is recorded in this manner, the absolute score calculation processing ends.

As described above, the analysis server 42 calculates the absolute score conversion rate from reference points assigned to each test, and converts a score of a test indicated by learning data into an absolute score. With this configuration, a recruiter or the like of a placement service can perform more reliable evaluation when evaluating the ability of each learner by browsing the absolute score.

<Description of Absolute Score Browsing Processing and Absolute Score Providing Processing>

When the absolute score calculation processing described with reference to FIG. 17 is performed, the client 71 participating in the blockchain network 41 can browse (reference) the absolute score data recorded in the blockchain database or the analysis server 42.

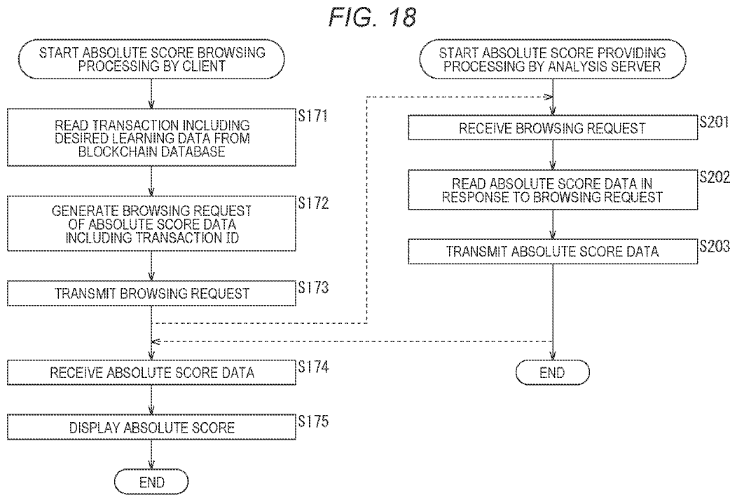

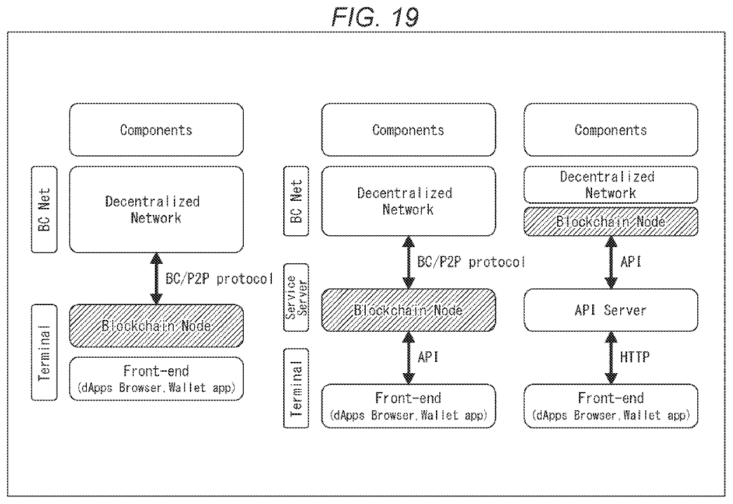

For example, as indicated by an arrow Q17 in FIG. 4, in a case where the recruiter b accesses the analysis server 42 by the client 71 and browses absolute score data, absolute score browsing processing and absolute score providing processing are performed as illustrated in FIG. 18.

Hereinafter, the absolute score browsing processing by the client 71 and the absolute score providing processing by the analysis server 42 will be described with reference to the flowchart of FIG. 18.

When the absolute score browsing processing is started, in step S171, the controller 84 of the client 71 reads a transaction including desired learning data from the blockchain database.

That is, the controller 84 generates a transaction requesting reading (browsing) of a transaction including desired learning data, supplies the transaction to the communication unit 81 to transmit the transaction to an endorsement peer, thereby requesting execution of the transaction.

As a result, the processing corresponding to procedures STP1 to STP4 described with reference to FIG. 3 is performed, and the communication unit 81 receives a response including a transaction requesting reading transmitted from the endorsement peer and supplies the response to the controller 84.

Additionally, at this time, the controller 84 supplies learning data, that is, a score indicated by the learning data included in the transaction supplied from the communication unit 81 to the display unit 85 as necessary, and causes the display unit 85 to display the score.

As a result, the recruiter b or the like who operates the client 71 can check the score of the test for the desired learner. At this time, in a case where the recruiter b or the like who has browsed the score desires to also browse the absolute score corresponding to the score, the recruiter b or the like operates the input unit 82 to give an instruction to browse the absolute score.

Then, in step S172, in response to the signal from the input unit 82, the controller 84 generates a request for browsing absolute score data including the transaction ID of the transaction supplied from the communication unit 81, and supplies the request to the communication unit 81.

With the transaction ID included in the browsing request, it is possible to identify the original score corresponding to the absolute score requested to be browsed. In other words, it is possible to identify, by the transaction ID, which absolute score for which test score of which learner is requested to be browsed.

In step S173, the communication unit 81 transmits the browsing request supplied from the controller 84 to the analysis server 42.

Then, in the analysis server 42, in step S201, the communication unit 151 receives the browsing request transmitted from the client 71 and supplies the browsing request to the controller 153.

In step S202, the controller 153 reads absolute score data in response to the browsing request supplied from the communication unit 151.

For example, in a case where the absolute score data is recorded in the recording unit 152, the controller 153 reads the absolute score data including the transaction ID included in the browsing request from the absolute score data recorded in the recording unit 152.

Additionally, for example, in a case where the absolute score data is not recorded in the recording unit 152, the controller 153 generates a transaction requesting reading of the absolute score data, more specifically, the transaction storing the absolute score data including the transaction ID included in the browsing request, and supplies the transaction to the communication unit 151.

Then, the controller 153 controls the communication unit 151 to transmit the generated transaction to an endorsement peer, thereby requesting execution of the transaction.

As a result, the processing corresponding to procedures STP1 to STP4 described with reference to FIG. 3 is performed, and the communication unit 151 receives the response including the transaction requesting reading transmitted from the endorsement peer and supplies the response to the controller 153.

The controller 153 extracts the absolute score data requested to be browsed from the transaction supplied from the communication unit 151 in this manner.

When the absolute score data is read as described above, the controller 153 supplies the absolute score data to the communication unit 151 and gives an instruction on transmission to the client 71.

In step S203, the communication unit 151 transmits the absolute score data supplied from the controller 153 to the client 71, and the absolute score providing processing ends.

Additionally, in the client 71, in step S174, the communication unit 81 receives the absolute score data transmitted from the analysis server 42 and supplies the absolute score data to the controller 84.

In step S175, the controller 84 supplies the absolute score data supplied from the communication unit 81 to the display unit 85 to display the absolute score.

As a result, the recruiter b or the like can check the absolute score requested to be browsed, and evaluates the ability of the learner by viewing the absolute score or the original score before conversion.

When the absolute score is displayed, the absolute score browsing processing ends.

As described above, the analysis server 42 transmits the absolute score data in response to the request of the client 71, and the client 71 receives the absolute score data transmitted from the analysis server 42 and displays the absolute score based on the absolute score data.

With this configuration, the recruiter or the like of the placement service can browse the absolute score and perform more reliable evaluation on each learner.

Note that while the example in which the client 71 reads the absolute score data from the analysis server 42 has been described here, the client 71 may read the absolute score data from the blockchain database using the transaction ID as a key.

Moreover, while a case where the blockchain network is a consortium type has been described above, the invention is not limited thereto, and the blockchain network may be in any form such as a public type. For example, the present technology can be implemented even in a case where a server or a client connected to a blockchain network functions as a node such as a peer.

That is, for example, as illustrated in FIG. 19, various devices can be caused to function as nodes in a blockchain network.

For example, in the example illustrated on the left side of FIG. 19, instead of the administrator of the blockchain network, an information terminal device (client) such as a user who uses the blockchain network functions as a node.

Additionally, for example, in the example illustrated in the center of FIG. 19, instead of the administrator of the blockchain network, a server of a business operator or the like that provides services to users and the like using the blockchain network functions as a node. In this case, the server of a business operator or the like connected to the blockchain network exchanges information with an information terminal device of a user or the like using the API, and provides a service to the user or the like.

Moreover, for example, in the example illustrated on the right side of FIG. 19, a device managed by the administrator of the blockchain network functions as a node. In this case, a server of a business operator or the like exchanges information with the node using the API. Additionally, the information terminal device of a user or the like is not directly connected to the node, and receives a service by exchanging information with the server of a business operator or the like.

### Computer Configuration Example

Incidentally, the series of processing described above can be performed by hardware or software. In a case where the series of processing is performed by software, a program that is included in the software is installed on a computer. Here, the computer includes a computer incorporated in dedicated hardware, a general-purpose personal computer, for example, that can execute various functions by installing various programs, and the like.

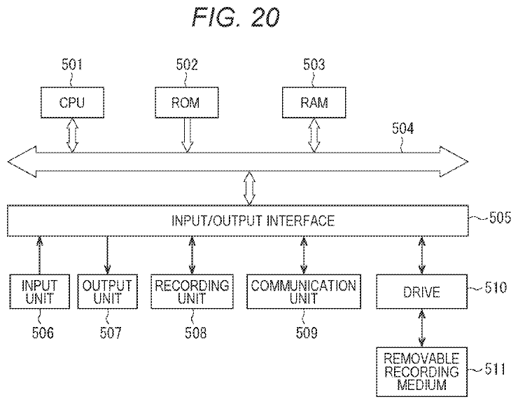

FIG. 20 is a block diagram illustrating a hardware configuration example of a computer that executes the series of processing described above according to a program.

In a computer, a central processing unit (CPU) 501, a read only memory (ROM) 502, and a random access memory (RAM) 503 are mutually connected by a bus 504.

An input/output interface 505 is also connected to the bus 504. An input unit 506, an output unit 507, a recording unit 508, a communication unit 509, and a drive 510 are connected to the input/output interface 505.

The input unit 506 includes a keyboard, a mouse, a microphone, an imaging device, and the like. The output unit 507 includes a display, a speaker, and the like. The recording unit 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, for example, the CPU 501 loads a program recorded in the recording unit 508 to the RAM 503 through the input/output interface 505 and the bus 504, and executes the program to perform the above-described series of processing.

The program executed by the computer (CPU 501) can be provided by being recorded on the removable recording medium 511 such as a package medium, for example. Additionally, the program can be provided through a wired or wireless transmission medium such as a local area network, the Internet, or digital satellite broadcasting.

In the computer, the program can be installed in the recording unit 508 through the input/output interface 505 by attaching the removable recording medium 511 to the drive 510. Additionally, the program can be received by the communication unit 509 through a wired or wireless transmission medium and be installed in the recording unit 508. In addition, the program can be installed in advance in the ROM 502 or the recording unit 508.

Note that the program executed by the computer may be a program that performs processing in chronological order according to the order described in the present specification, or a program that performs processing in parallel, or at a necessary timing such as when a call is made.

Additionally, the embodiment of the present technology is not limited to the above-described embodiment, and various modifications can be made without departing from the scope of the present technology.

For example, the present technology can have a cloud computing configuration in which one function is shared and jointly processed by a plurality of devices through a network.

Additionally, each step described in the above-described flowchart can be executed by one device or be executed in a shared manner by a plurality of devices.

Moreover, in a case where a plurality of processes is included in one step, the plurality of processes included in one step can be executed by one device or be executed in a shared manner by a plurality of devices.

Moreover, the present technology may have the following configurations.

(1)

An information processing method including:
an acquisition step of acquiring, for a plurality of evaluators, evaluation data indicating evaluation of an evaluation target generated by the evaluator and a value indicating worth of the evaluator;
a conversion step of converting the evaluation data into absolute evaluation data on the basis of the evaluation data and the value indicating the worth of the plurality of evaluators; and
a recording step of recording the absolute evaluation data in a distributed ledger.

(2)

The information processing method according to (1), in which
the value indicating the worth increases as the number of times of reference of the evaluation data generated by the evaluator increases.

(3)

The information processing method according to (2), in which
in the conversion step, the evaluation data is converted into the absolute evaluation data on the basis of the evaluation data and the value indicating the worth belonging to the same category.

(4)

The information processing method according to (2) or (3) further including a conversion rate calculation step of calculating an absolute evaluation conversion rate for converting the evaluation data into the absolute evaluation data on the basis of the evaluation data and the value indicating the worth of the plurality of evaluators, in which
in the conversion step, the evaluation data is converted into the absolute evaluation data on the basis of the absolute evaluation conversion rate.

(5)

The information processing method according to (4), in which
in the conversion rate calculation step, for each of a predetermined number of evaluators serving as a reference, a conversion rate at which the evaluation data of another evaluator is converted into the evaluation data corresponding to the evaluation data of the evaluator serving as the reference is calculated, and the absolute evaluation conversion rate is calculated on the basis of the conversion rate and the value indicating the worth of each of the evaluators serving as the reference.

(6)

The information processing method according to (5), in which
in the conversion rate calculation step, the absolute evaluation conversion rate is obtained by performing weighted summing of the conversion rate using the value indicating the worth as a weight.

(7)

The information processing method according to any one of (2) to (6), in which
the evaluation data is a score of a test provided by a test provider as the evaluator.

(8)

The information processing method according to (7), in which
the value indicating the worth of the evaluator is granted for each of the tests.

(9)

A program for causing a computer to execute processing including:
an acquisition step of acquiring, for a plurality of evaluators, evaluation data indicating evaluation of an evaluation target generated by the evaluator and a value indicating worth of the evaluator;
a conversion step of converting the evaluation data into absolute evaluation data on the basis of the evaluation data and the value indicating the worth of the plurality of evaluators; and
a recording step of recording the absolute evaluation data in a distributed ledger.

(10)

An information processing device including:
an acquisition unit that acquires, for a plurality of evaluators, evaluation data indicating evaluation of an evaluation target generated by the evaluator and a value indicating worth of the evaluator;
a conversion unit that converts the evaluation data into absolute evaluation data on the basis of the evaluation data and the value indicating the worth of the plurality of evaluators; and
a controller that performs control to record the absolute evaluation data in a distributed ledger.

(11)

An information processing method including
in a case where a distributed ledger is shared by a plurality of devices, the distributed ledger being formed by connecting blocks generated on the basis of a transaction storing learning data including identification information of a test provided by a test provider, learner information indicating a learner who has taken the test, and a score of the test of the learner, in response to reference to the learning data recorded in the distributed ledger, assigning a reference point to the test or the test provider providing the test indicated by the identification information included in the referenced learning data.

(12)

The information processing method according to (11), in which
the transaction storing the learning data is recorded in the distributed ledger for the test provided by each of a plurality of the test providers.

(13) The information processing method according to (12), in which
the learning data further includes at least one of examiner information indicating the test provider or category information indicating a category of the test.

(14)

The information processing method according to any one of (11) to (13), in which
in a case where the same viewer references the learning data of the same test a plurality of times, the reference point granted to the test or the test provider decreases every time the number of times of reference increases.

(15)

The information processing method according to any one of (11) to (14), in which
a transaction storing another learning data including a transaction ID indicating each of a plurality of the transactions is further recorded in the distributed ledger.

(16) The information processing method according to (15), in which
in a case where the other learning data is referenced, a reference point is granted to the test or the test provider for each of the learning data stored in each of the plurality of transactions.

(17)

A program for causing a computer to execute processing of
in a case where a distributed ledger is shared by a plurality of devices, the distributed ledger being formed by connecting blocks generated on the basis of a transaction storing learning data including identification information of a test provided by a test provider, learner information indicating a learner who has taken the test, and a score of the test of the learner, in response to reference to the learning data recorded in the distributed ledger, assigning a reference point to the test or the test provider providing the test indicated by the identification information included in the referenced learning data.

(18)

An information processing device that shares, with another device, a distributed ledger formed by connecting blocks generated on the basis of a transaction storing learning data including identification information of a test provided by a test provider, learner information indicating a learner who has taken the test, and a score of the test of the learner, the information processing device including a controller that, in response to reference to the learning data recorded in the distributed ledger, assigns a reference point to the test or the test provider providing the test indicated by the identification information included in the referenced learning data.

### REFERENCE SIGNS LIST

11 Client
12 Endorsement peer
13 Orderer
14 Committing peer
41 Blockchain network
42 Analysis server
111 Peer
121 Communication unit
122 Recording unit
123 Controller
151 Communication unit
152 Recording unit
153 Controller
161 Acquisition unit
162 Conversion rate calculator
163 Score converter

1. An information processing method comprising:
an acquisition step of acquiring, for a plurality of evaluators, evaluation data indicating evaluation of an evaluation target generated by the evaluator and a value indicating worth of the evaluator;
a conversion step of converting the evaluation data into absolute evaluation data on a basis of the evaluation data and the value indicating the worth of the plurality of evaluators; and
a recording step of recording the absolute evaluation data in a distributed ledger.

2. The information processing method according to claim 1, wherein
the value indicating the worth increases as the number of times of reference of the evaluation data generated by the evaluator increases.

3. The information processing method according to claim 2, wherein
in the conversion step, the evaluation data is converted into the absolute evaluation data on a basis of the evaluation data and the value indicating the worth belonging to the same category.

4. The information processing method according to claim 2 further comprising a conversion rate calculation step of calculating an absolute evaluation conversion rate for converting the evaluation data into the absolute evaluation data on a basis of the evaluation data and the value indicating the worth of the plurality of evaluators, wherein
in the conversion step, the evaluation data is converted into the absolute evaluation data on a basis of the absolute evaluation conversion rate.

5. The information processing method according to claim 4, wherein
in the conversion rate calculation step, for each of a predetermined number of evaluators serving as a reference, a conversion rate at which the evaluation data of another evaluator is converted into the evaluation data corresponding to the evaluation data of the evaluator serving as the reference is calculated, and the absolute evaluation conversion rate is calculated on a basis of the conversion rate and the value indicating the worth of each of the evaluators serving as the reference.

6. The information processing method according to claim 5, wherein
in the conversion rate calculation step, the absolute evaluation conversion rate is obtained by performing weighted summing of the conversion rate using the value indicating the worth as a weight.

7. The information processing method according to claim 2, wherein
the evaluation data is a score of a test provided by a test provider as the evaluator.

8. The information processing method according to claim 7, wherein
the value indicating the worth of the evaluator is granted for each of the tests.

9. A program for causing a computer to execute processing comprising:
an acquisition step of acquiring, for a plurality of evaluators, evaluation data indicating evaluation of an evaluation target generated by the evaluator and a value indicating worth of the evaluator;
a conversion step of converting the evaluation data into absolute evaluation data on a basis of the evaluation data and the value indicating the worth of the plurality of evaluators; and
a recording step of recording the absolute evaluation data in a distributed ledger.

10. An information processing device comprising:
an acquisition unit that acquires, for a plurality of evaluators, evaluation data indicating evaluation of an evaluation target generated by the evaluator and a value indicating worth of the evaluator;
a conversion unit that converts the evaluation data into absolute evaluation data on a basis of the evaluation data and the value indicating the worth of the plurality of evaluators; and
a controller that performs control to record the absolute evaluation data in a distributed ledger.

11. An information processing method comprising
in a case where a distributed ledger is shared by a plurality of devices, the distributed ledger being formed by connecting blocks generated on a basis of a transaction storing learning data including identification information of a test provided by a test provider, learner information indicating a learner who has taken the test, and a score of the test of the learner, in response to reference to the learning data recorded in the distributed ledger, assigning a reference point to the test or the test provider providing the test indicated by the identification information included in the referenced learning data.

12. The information processing method according to claim 11, wherein
the transaction storing the learning data is recorded in the distributed ledger for the test provided by each of a plurality of the test providers.

13. The information processing method according to claim 12, wherein
the learning data further includes at least one of examiner information indicating the test provider or category information indicating a category of the test.

14. The information processing method according to claim 11, wherein
in a case where the same viewer references the learning data of the same test a plurality of times, the reference point granted to the test or the test provider decreases every time the number of times of reference increases.

15. The information processing method according to claim 11, wherein
a transaction storing another learning data including a transaction ID indicating each of a plurality of the transactions is further recorded in the distributed ledger.

16. The information processing method according to claim 15, wherein
in a case where the other learning data is referenced, a reference point is granted to the test or the test provider for each of the learning data stored in each of the plurality of transactions.

17. A program for causing a computer to execute processing of
in a case where a distributed ledger is shared by a plurality of devices, the distributed ledger being formed by connecting blocks generated on a basis of a transaction storing learning data including identification information of a test provided by a test provider, learner information indicating a learner who has taken the test, and a score of the test of the learner, in response to reference to the learning data recorded in the distributed ledger, assigning a reference point to the test or the test provider providing the test indicated by the identification information included in the referenced learning data.

18. An information processing device that shares, with another device, a distributed ledger formed by connecting blocks generated on a basis of a transaction storing learning data including identification information of a test provided by a test provider, learner information indicating a learner who has taken the test, and a score of the test of the learner, the information processing device including
a controller that, in response to reference to the learning data recorded in the distributed ledger, assigns a reference point to the test or the test provider providing the test indicated by the identification information included in the referenced learning data.
